(19) United States
(12) Patent Application Publication
(10) Pub. No.: US 2024/0268271 A1
(43) Pub. Date: Aug. 15, 2024

(54) Combine

(71) Applicant: Kubota Corporation, Osaka-shi (JP)

(72) Inventors: Takafumi Mitsui, Sakai-shi (JP); Toshinari Nishimura, Sakai-shi (JP)

(21) Appl. No.: 18/566,870

(22) PCT Filed: Jun. 7, 2022
(86) PCT No.: PCT/JP2022/022979

§ 371 Date: Dec. 4, 2023

(30) Foreign Application Priority Data
Jun. 9, 2021 (JP) 2021-096679

(51) Int. Cl. A01F 12/22; A01F 12/32; A01F 12/48

(52) U.S. Cl. CPC A01F 12/22; A01F 12/32; A01F 12/48

(57) ABSTRACT

A combine includes a sorter 2B including a sieve case 23 drivable to swing; a first chaff sieve 27 held by the sieve case 23 and configured to receive a processing target falling through a receiver net 8 and sort the processing target; a second chaff sieve 28 held by the sieve case 23 in such a manner as to coincide with the first chaff sieve 27 in the front-back direction relative to the sorter 2B and configured to receive a processing target falling through the first chaff sieve 27 and sort the processing target; and a winnowing fan 29 configured to blow sorting air along the first and second chaff sieves 27 and 28.

### CROSS-REFERENCE TO RELATED APPLICATIONS

This application is the United States national phase of International Application No. PCT/JP2022/022979 filed Jun. 7, 2022, and claims priority to Japanese Patent Application No. 2021-096679 filed Jun. 9, 2021, the disclosures of which are hereby incorporated by reference in their entireties.

### BACKGROUND OF THE INVENTION

### Field of the Invention

The present invention relates to combines.

### Description of Related Art

A combine may include: a reaper configured to reap a crop planted in an agricultural field; and a thresher device including: a thresher chamber configured to receive the whole reaped crop that the reaper has reaped; a thresher cylinder disposed rotatably in the thresher chamber and configured to thresh the reaped crop that the thresher chamber has received; a receiver net below the thresher cylinder; and a sorter configured to sort a processing target falling through the receiver net. The thresher cylinder of the combine may include: a thresher cylinder shaft disposed rotatably in the thresher chamber and extending in a front-back direction relative to the thresher chamber; a plurality of bar-shaped thresher teeth supports held by and extending along the thresher cylinder shaft and apart from one another in a circumferential direction of the thresher cylinder; and a plurality of bar-shaped thresher teeth provided for and held by each of the plurality of thresher teeth supports, protruding from the thresher teeth support outward in a radial direction of the thresher cylinder, and apart from one another along the thresher cylinder shaft.

Combines of this type thresh a threshing target in a threshing space between the outer surface of the thresher cylinder and the receiver net by causing, for example, the thresher teeth supports and the thresher teeth to hit the threshing target and the thresher teeth to comb the threshing target. The combine allows a processing target resulting from the threshing process to enter an internal space of the thresher cylinder through the spaces between adjacent thresher teeth supports which internal space is inward of the thresher teeth supports. The combine stirs the processing target in the threshing space and the processing target in the internal space, and simultaneously threshes the processing targets by causing, for example, the thresher teeth supports and the thresher teeth to hit the processing targets and the thresher teeth to comb the processing targets. The combine is thus capable of an accurate threshing process even when the combine receives a large amount of reaped crops into the thresher chamber as a threshing target.

### PATENT LITERATURE

### Patent Literature 1

Japanese Unexamined Patent Application Publication, Tokukai, No. 2020-18198

### SUMMARY OF INVENTION

The combine is capable of an accurate threshing process even when the combine receives a large amount of a threshing target into the thresher chamber. However, unless the sorter is capable of accurately sorting a large amount of a processing target from the thresher, the operator is unable to drive the combine at very high speeds while reaping crops to avoid receiving a very large amount of reaped crops into the thresher chamber.

The present invention provides a combine including a simply structured sorter and capable of traveling and reaping crops at high speeds while causing the sorter to perform an accurate sorting process.

A combine according to the present invention includes: a reaper configured to reap a crop planted in an agricultural field; and a thresher device including: a thresher chamber configured to receive the whole reaped crop that the reaper has reaped; a thresher cylinder disposed rotatably in the thresher chamber and configured to thresh the reaped crop that the thresher chamber has received; a receiver net below the thresher cylinder; and a sorter configured to sort a processing target falling through the receiver net, the thresher cylinder including: a thresher cylinder shaft disposed rotatably in the thresher chamber and extending in a front-back direction relative to the thresher chamber; a plurality of bar-shaped thresher teeth supports held by and extending along the thresher cylinder shaft and apart from one another in a circumferential direction of the thresher cylinder; and a plurality of bar-shaped thresher teeth provided for and held by each of the plurality of thresher teeth supports, protruding from the thresher teeth support outward in a radial direction of the thresher cylinder, and apart from one another along the thresher cylinder shaft, the sorter including: a sieve case disposed below the receiver net and drivable to swing; a first chaff sieve held inside the sieve case and configured to receive the processing target falling through the receiver net and sort the processing target while conveying the processing target backward relative to the sorter; a second chaff sieve held by the sieve case in such a manner as to coincide with the first chaff sieve in a front-back direction relative to the sorter and be below the first chaff sieve and configured to receive the processing target falling through the first chaff sieve and sort the processing target while conveying the processing target backward relative to the sorter; and a winnowing fan disposed at a front portion of the sorter and configured to blow sorting air backward relative to the sorter along the first and second chaff sieves.

The combine is configured as follows: The first chaff sieve receives a threshed product falling through the receiver net. The first chaff sieve sieves the threshed product to sort the threshed product, while the winnowing fan blows sorting air toward the threshed product to sort the threshed product. The second chaff sieve receives a processing target resulting from the sorting process. The second chaff sieve sieves the processing target to sort the processing target, while the winnowing fan blows sorting air toward the processing target to sort the processing target. The sorter is thereby capable of accurately sorting even a large amount of a threshed product as a sorting target that the thresher cylinder and the receiver net have accurately threshed. The combine therefore includes a simply structured sorter, which includes first and second chaff sieves swingable by a single sieve case, and is capable of traveling and reaping crops at high speeds while causing the sorter to perform an accurate sorting process.

The present invention may preferably be further configuration such that the thresher cylinder shaft is horizontal.

The above configuration allows a processing target to be easily dispersed uniformly in the front-back direction relative to the thresher cylinder in, for example, a processing space between the outer surface of the thresher cylinder and the receiver net and the internal space of the thresher cylinder. This facilitates threshing a large amount of a processing target. The combine is thereby capable of threshing a large amount of a processing target more accurately.

The present invention may preferably further include: a first-grain screw conveyor disposed backward of the winnowing fan and configured to collect a first sorted product and convey the first sorted product widthwise relative to the sorter; and a second-grain screw conveyor disposed backward of the first-grain screw conveyor and configured to collect a second sorted product and convey the second sorted product widthwise relative to the sorter, wherein the first and second chaff sieves have respective front portions forward of a center of the first-grain screw conveyor, and the first and second chaff sieves have respective back portions backward of a center of the second-grain screw conveyor.

With the above configuration, the first and second chaff sieves extend widely across the front-back direction relative to the sorter, and sort a processing target sufficiently. This allows the first and second chaff sieves to sort a processing target more accurately.

The present invention may preferably further include: a guide extending from below the back portion of the second chaff sieve in a forward and downward direction past a space above the second-grain screw conveyor toward the first-grain screw conveyor and configured to guide the first sorted product to the first-grain screw conveyor.

With the above configuration, the guide guides a first sorted product falling through the second chaff sieve to the first-grain screw conveyor accurately to be collected thereby. The above configuration thereby facilitates collecting a first sorted product while preventing it from escaping.

The present invention may preferably be further configuration such that the winnowing fan is configured to draw in the sorting air from laterally outside the winnowing fan and discharge the sorting air backward relative to the winnowing fan, and the combine further includes a cylindrical air duct disposed between the winnowing fan and the first and second chaff sieves and configured to guide the sorting air from the winnowing fan toward the first and second chaff sieves.

The above configuration allows the winnowing fan to draw in sorting air and discharge its entirety backward, and also involves a cylindrical air duct configured to guide the sorting air from the winnowing fan toward the first and second chaff sieves. This allows sorting air to be blown toward the first and second chaff sieves stably without escaping, and thereby allows the first and second chaff sieves to sort a processing target accurately.

The present invention may preferably be further configuration such that the air duct has an air outlet forward of and facing the first and second chaff sieves.

The above configuration allows the air duct to blow sorting air accurately toward the first and second chaff sieves. This in turn allows sorting air to reliably reach the first and second chaff sieves, and thereby allows the first and second chaff sieves to sort a processing target accurately.

The present invention may preferably be further configuration such that the air duct is configured to blow the sorting air along a direction in which the first and second chaff sieves extend.

The above configuration allows sorting air from the air duct to flow along the first and second chaff sieves. This in turn allows sorting air to reliably reach the entire first and second chaff sieves, and thereby allows the first and second chaff sieves to sort a processing target accurately.

The present invention may preferably be further configuration such that the thresher cylinder further includes: a raker section disposed at a front portion of the thresher cylinder and configured to rake backward relative to the thresher chamber the reaped crop that the thresher chamber has received; and a thresher section connected to a back portion of the raker section and including the thresher teeth supports and the thresher teeth, and the winnowing fan includes a rotary blade with a rotation axis extending widthwise relative to the sorter and coinciding with the raker section in the front-back direction relative to the sorter.

The above configuration ensures a large distance between the air outlet of the winnowing fan and the first and second chaff sieves, and allows use of a long cylindrical air duct. The air duct guides sorting air from the winnowing fan accurately toward the first and second chaff sieves. This allows sorting air to be blown toward the first and second chaff sieves stably without escaping, and thereby allows the first and second chaff sieves to sort a processing target accurately.

### BRIEF DESCRIPTION OF THE DRAWING

FIG. 1 is a cross-sectional view of a thresher device of a combine.

### DESCRIPTION OF THE INVENTION

The description below deals with an example embodiment of the present invention with reference to a drawing.

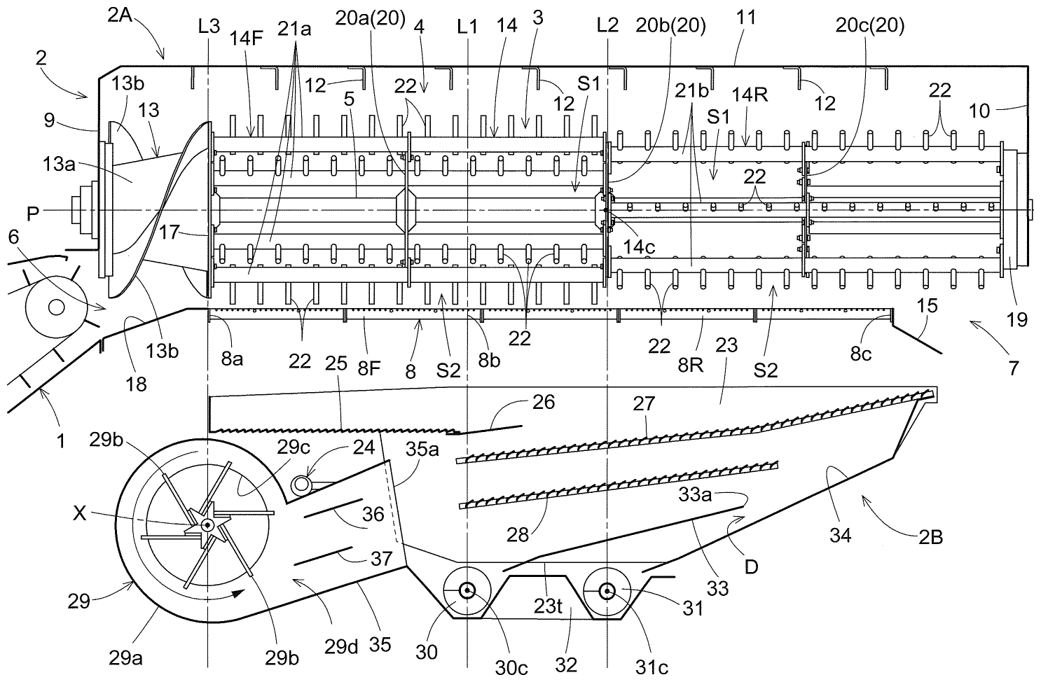

The present embodiment is a combine including a body, travel devices supporting the body such as front and rear wheels, a driver section provided for the body and configured to accommodate an operator, and a motive section provided for the body and including an engine (the drawing does not show the entire configuration of the combine). The combine includes a reaper-conveyor disposed at a front portion of the body and configured to reap crops standing upright in an agricultural field such as rice and wheat and convey the reaped crops backward. The reaper-conveyor includes a reaper configured to reap planted crops and a feeder 1 (see FIG. 1) as a conveyor device configured to convey the crops that the reaper has reaped. The combine includes a thresher device 2 and a grain tank at a back portion of the body. The thresher device 2 (see FIG. 1) is configured to receive reaped grain culms as a threshing target that the feeder 1 conveys, thresh the grain culms, and sort the threshed product. The grain tank (not illustrated in the drawings) is configured to collect and store grain as sorted.

### Configuration of Thresher Device

The description below deals with a thresher device 2 and a thresher cylinder 3. The description below uses terms such as “front” and “forward” to refer to the side on which the thresher device 2 and the thresher cylinder 3 start their process or receive grain culms (that is, the left side of FIG. 1) and terms such as “back” and “backward” to refer to the side on which the thresher device 2 and the thresher cylinder 3 end their process or discharge grain culms (that is, the right side of FIG. 1).

As illustrated in FIG. 1, the thresher device 2 includes a thresher 2A and a sorter 2B. The thresher 2A is configured to receive reaped grain culms as reaped crops from the feeder 1 and thresh the grain culms as a threshing target. The sorter 2B is disposed below the thresher 2A and configured to sort a threshed product.

As illustrated in FIG. 1, the thresher 2A includes a thresher cylinder 3, a thresher chamber 4 disposed at an upper portion of the thresher device 2 and containing the thresher cylinder 3, a thresher cylinder shaft 5 about which the thresher cylinder 3 is drivable to rotate, a feed opening 6 disposed in a front lower portion of the thresher chamber 4 for receiving a threshing target into the thresher chamber 4, a culm discharge section 7 disposed at a back lower portion of the thresher chamber 4 for discharging waste culms from the thresher chamber, and a receiver net 8 disposed in a portion of the area around the thresher cylinder 3 which portion is below the thresher cylinder 3.

The thresher chamber 4 is defined by, for example, a front wall 9 and a back wall 10 both holding the thresher cylinder 3, a top plate 11 covering the thresher chamber 4 from above, and the receiver net 8. The top plate 11 has an inner side provided with dust-transmitting valves arranged in the front-back direction relative to the thresher chamber. The thresher cylinder 3, as illustrated in FIG. 1, includes a raker section 13 at a front portion of the thresher cylinder 3 and a thresher section 14 disposed at a portion of the thresher cylinder 3 which portion is backward of the raker section 13 and connected to a back portion of the raker section 13.

The thresher 2A is configured such that the thresher chamber 4 receives reaped grain culms from the feeder 1 through the feed opening 6, that the raker section 13 rakes the whole reaped grain culms (that is, from the plant root to the tip) into the thresher chamber 4 as a threshing target, and that the thresher section 14 and the receiver net 8 thresh the reaped grain culms. The thresher section 14 rotates to provide revolving power to the threshing target and cause the threshing target to hit the dust-transmitting valves 12, which then guide the threshing target backward through the thresher chamber 4. The thresher section 14 threshes the threshing target while conveying the threshing target backward relative to the thresher chamber 4. The receiver net 8 receives grains resulting from the threshing process, and lets the grains fall therethrough. The threshing process generates waste culms, chaff, and the like, which are discharged from the thresher chamber 4 through the culm discharge section 7 and guided by a discharge guide 15 to drop to outside the sorter 2B. The discharge guide 15 extends from the back end of the receiver net 8 in a backward and downward direction to backward of a sieve case 23 of the sorter 2B, and guides waste culms, chaff, and the like so that the waste culms, chaff, and the like drop to backward of the sieve case 23.

### Configuration of Thresher Cylinder

The thresher cylinder 3 is, as illustrated in FIG. 1, disposed in the thresher chamber 4 in the front-back direction relative to the thresher chamber 4. The thresher cylinder 3 includes a thresher cylinder shaft 5 drivable to rotate about a thresher cylinder axis P, a raker section 13 held by a front portion of the thresher cylinder shaft 5, and a thresher section 14 held by a portion of the thresher cylinder shaft 5 which portion is backward of the raker section 13. The raker section 13 has a back portion connected to a front portion of the thresher section 14. The thresher cylinder shaft 5 is held horizontally by the front wall 9 and the back wall 10.

### Configuration of Raker Section

The raker section 13, as illustrated in FIG. 1, includes a base 13a and two spiral blades 13b. The base 13a tapers forward relative to the thresher cylinder 3. The spiral blades 13b stand on the outer surface of the base 13a. The spiral blades 13b are, as with a double helix, apart from each other in the circumferential direction of the base 13a, and extend from the back end of the base 13a to its leading end.

The base 13a is made of a metal sheet rolled in the shape of a circular truncated cone. The base 13a is held by the thresher cylinder shaft 5 with use of a disk (not illustrated in the drawings) coupling a front end portion of the base 13a to the thresher cylinder shaft 5 and a front support 17 coupling a back end portion of the base 13a to the thresher cylinder shaft 5.

The raker section 13 is configured such that the base 13a is driven by the thresher cylinder shaft 5 through the disk and the front support 17 and that the spiral blades 13b are thereby driven to rotate about the thresher cylinder axis P. The spiral blades 13b rotate to rake the whole reaped grain culms (that is, from the plant root to the tip), which are received from the feeder 1 through the feed opening 6 into the thresher chamber 4, along a bottom guide plate 18 (see FIG. 1) backward relative to the thresher chamber 4.

### Configuration of Thresher Section

The thresher section 14, as illustrated in FIG. 1, includes a front support 17, a back support 19, and three intermediate supports 20. The front support 17 is held by a portion of the thresher cylinder shaft 5 which portion corresponds to a back portion of the raker section 13. The back support 19 is held by a portion of the thresher cylinder shaft 5 which portion is backward of the front support 17. The intermediate supports 20 are each held by a portion of the thresher cylinder shaft 5 which portion is between the front and back supports 17 and 19, and are apart from one another at equal intervals in the front-back direction relative to the thresher cylinder shaft 5. The description below refers to the front intermediate support 20 as a first intermediate support 20a, the middle intermediate support 20 as a second intermediate support 20b, and the back intermediate support 20 as a third intermediate support 20c.

The thresher section 14, as illustrated in FIG. 1, includes a front thresher subsection 14F and a rear thresher subsection 14R. The front thresher subsection 14F is disposed forward of the second intermediate support 20b and includes six bar-shaped front divisional thresher teeth supports 21a. The rear thresher subsection 14R is disposed backward of the second intermediate support 20b and includes six bar-shaped rear divisional thresher teeth supports 21b. The front and rear divisional thresher teeth supports 21a and 21b each result from a single thresher teeth support that is equal in the front-back dimension to the combination of the front and rear divisional thresher teeth supports 21a and 21b which thresher teeth support is divided at the second intermediate support 20b into a front-back arrangement. The front and rear divisional thresher teeth supports 21a and 21b are shifted in position from each other in the circumferential direction of the thresher cylinder 3.

As illustrated in FIG. 1, the front thresher subsection 14F includes six bar-shaped front divisional thresher teeth supports 21a held by and extending along the thresher cylinder shaft 5 and apart from one another in the circumferential direction of the thresher cylinder 3. The front divisional thresher teeth supports 21a are held by the thresher cylinder shaft 5 with the front support 17 and the first and second intermediate supports 20a and 20b in-between. The front divisional thresher teeth supports 21a are arranged at equal intervals in the circumferential direction of the thresher cylinder 3 as the front divisional thresher teeth supports 21a are held by the thresher cylinder shaft 5. The front divisional thresher teeth supports 21a each hold bar-shaped thresher teeth 22 apart from one another along the thresher cylinder shaft 5. The thresher teeth 22 on each front divisional thresher teeth support 21a protrude outward in the radial direction of the thresher cylinder 3 from the front divisional thresher teeth support 21a.

As illustrated in FIG. 1, the rear thresher subsection 14R includes six bar-shaped rear divisional thresher teeth supports 21b held by and extending along the thresher cylinder shaft 5 and apart from one another in the circumferential direction of the thresher cylinder 3. The rear divisional thresher teeth supports 21b are held by the thresher cylinder shaft 5 with the second and third intermediate supports 20b and 20c and the back support 19 in-between. The rear divisional thresher teeth supports 21b are arranged at equal intervals in the circumferential direction of the thresher cylinder 3 as the rear divisional thresher teeth supports 21b are held by the thresher cylinder shaft 5. The rear divisional thresher teeth supports 21b each hold bar-shaped thresher teeth 22 apart from one another along the thresher cylinder shaft 5. The thresher teeth 22 on each rear divisional thresher teeth support 21b protrude outward in the radial direction of the thresher cylinder 3 from the rear divisional thresher teeth support 21b.

The present embodiment includes six front and rear divisional thresher teeth supports 21a and 21b, but may alternatively include five or less or seven or more. The present embodiment is configured such that the front and rear divisional thresher teeth supports 21a and 21b are each a round steel pipe. The front and rear divisional thresher teeth supports 21a and 21b may each be, other than a round steel pipe, any of various bars such as a round steel member, a square steel bar, and a square steel pipe. The front and rear divisional thresher teeth supports 21a and 21b may each be an angular or channel member as well. The present embodiment is configured such that the thresher teeth 22 are each a round steel member. The thresher teeth 22 may each be, other than a round steel member, any of various bars such as a square steel bar, a round pipe, and a square pipe.

The thresher cylinder 3 is in the form of a basket with an internal space S1 (see FIG. 1) that communicates with the thresher chamber 4 through the spaces between adjacent front divisional thresher teeth supports 21a and the spaces between adjacent rear divisional thresher teeth supports 21b. The thresher cylinder 3, which is made of the front and rear divisional thresher teeth supports 21a and 21b, is provided with thresher teeth 22 arranged apart from one another in the circumferential direction of the thresher cylinder 3 and in the process direction and protruding outward in the radial direction of the thresher cylinder from its outer surface. The thresher cylinder 3 has a so-called bar shape.

The thresher cylinder 3 thus rotates about the thresher cylinder shaft 5, which is oriented in the process direction, to introduce a threshing target from the raker section 13 into the space between the thresher section 14 and the receiver net 8. The thresher cylinder 3 threshes a threshing target in a threshing space S2 (see FIG. 1) between the outer surface of the thresher cylinder and the receiver net 8 by causing, for example, the front and rear divisional thresher teeth supports 21a and 21b and the thresher teeth 22 to hit the threshing target and the thresher teeth 22 to comb the threshing target. The thresher cylinder 3 allows a processing target resulting from the threshing process to enter the internal space S1. The thresher cylinder 3 stirs and mixes the processing target in the threshing space S2 and the processing target in the internal space S1, and simultaneously threshes the processing targets by causing, for example, the front and rear divisional thresher teeth supports 21a and 21b and the thresher teeth 22 to hit the processing targets and the thresher teeth 22 to comb the processing targets.

### Configuration of Sorter

The description below deals with the sorter 2B. The description below uses terms such as “front” and “forward” to refer to the end at which the sorter 2B starts its process (that is, the left side of FIG. 1) and terms such as “back” and “backward” to refer to the end at which sorter 2B ends its process (that is, the right side of FIG. 1).

As illustrated in FIG. 1, the sorter 2B includes a sieve case 23 under the receiver net 8 and a drive mechanism 24 disposed under and coupled to a front portion of the sieve case 23. The sorter 2B also includes a holder (not illustrated in the drawings) disposed at a back portion of the sieve case 23 and swingably held by a thresher frame (not illustrated in the drawings). The sieve case 23 is drivable by the drive mechanism 24 to swing about the holder at the back portion.

The sorter 2B includes a grain pan 25 held inside the sieve case 23 and at a front portion thereof.

FIG. 1 shows a vertical line L1 extending through the center 30c of a first-grain screw conveyor 30. The grain pan 25 is under a front portion 8F of the receiver net 8, that is, that portion of the receiver net 8 which is between the front end 8a and an intermediate portion 8b through which the vertical line L1 extends. The sorter 2B includes a sieve line 26 extending backward from a back end portion of the grain pan 25 and a first chaff sieve 27 and a second chaff sieve 28 both held in a back portion of the sieve case 23. The first chaff sieve 27 is under a back portion 8R of the receiver net 8. The second chaff sieve 28 is held by the sieve case 23 in such a manner as to coincide with the first chaff sieve 27 in the front-back direction relative to the sorter 2B and be under the first chaff sieve 27.

The sorter 2B includes a winnowing fan 29 disposed at a front portion thereof and configured to blow sorting air backward relative to the sorter 2B along the first and second chaff sieves 27 and 28.

The sorter 2B includes a first-grain screw conveyor 30 disposed backward of the winnowing fan 29 and under the bottom 23t of the sieve case 23 and configured to collect and convey a first sorted product (that is, singled grains). The sorter 2B also includes a second-grain screw conveyor 31 disposed backward of the first-grain screw conveyor 30 and under the bottom 23t of the sieve case 23 and configured to collect and convey a second sorted product (that is, unsingled grains). The first-grain screw conveyor 30 and the second-grain screw conveyor 31 each extend widthwise relative to the sorter 2B and each convey its collected first or second sorted product widthwise relative to the sorter 2B to laterally outside the thresher device 2. The sorter 2B includes a frame 32 supporting the first-grain screw conveyor 30 and the second-grain screw conveyor 31 and supported by a body frame (not illustrated in the drawings) of the body.

FIG. 1 shows a vertical line L1 extending through the center 30c (rotation axis) of the first-grain screw conveyor 30 and a vertical line L2 extending through the center 31c (rotation axis) of the second-grain screw conveyor 31 and a central portion 14c of the thresher section 14 in the front-back direction. As illustrated in FIG. 1, the first and second chaff sieves 27 and 28 have respective front portions forward of the center 30c of the first-grain screw conveyor 30. The first chaff sieve 27 has a back portion backward of the back end 8c of the receiver net 8. The first and second chaff sieves 27 and 28 have respective back portions backward of the center 31c of the second-grain screw conveyor 31. The sorter 2B includes a first-grain guide 33 disposed below the second chaff sieve 28 and held by the sieve case 23. The first-grain guide 33 extends from under a back end portion of the second chaff sieve 28 in a forward and downward direction past a space over the second-grain screw conveyor 31 toward the first-grain screw conveyor 30. The first-grain guide 33 is configured to guide a first sorted product to the first-grain screw conveyor 30. The sorter 2B also includes a second-grain guide 34 disposed at a back edge portion of the sieve case 23 and held by the sieve case 23. The second-grain guide 34 extends from under a back end portion of the first chaff sieve 27 in a forward and downward direction toward the second-grain screw conveyor 31. The second-grain guide 34 is configured to guide a second sorted product to the second-grain screw conveyor 31. The first-grain guide 33 has a back end portion 33a separated from the second-grain guide 34 by a gap D for a second sorted product to pass through.

The sorter 2B is configured such that the drive mechanism 24 swings the sieve case 23, which in turn swings the grain pan 25 and the first and second chaff sieves 27 and 28. The grain pan 25 receives a threshed product falling through the front portion 8F of the receiver net 8 as a sorting target, and sorts the sorting target while conveying the sorting target backward relative to the sorter 2B. The first chaff sieve 27 receives the sorting target from the grain pan 25 and a threshed product falling through the back portion 8R of the receiver net 8 as a sorting target. While the first chaff sieve 27 conveys the received sorting target backward relative to the sorter 2B, the first chaff sieve 27 sieves the sorting target to sort the sorting target, and simultaneously the winnowing fan 29 blows sorting air toward the sorting target to sort the sorting target. The second chaff sieve 28 receives the sorting target falling through the first chaff sieve 27. While the second chaff sieve 28 conveys the received sorting target backward relative to the sorter 2B, the second chaff sieve 28 sieves the sorting target to sort the sorting target, and simultaneously the winnowing fan 29 blows sorting air toward the sorting target to sort the sorting target. The first-grain guide 33 receives a first sorted product (that is, singled grains) falling through the second chaff sieve 28 and guides the first sorted product to the first-grain screw conveyor 30 to be collected thereby. The first-grain screw conveyor 30 conveys the collected first sorted product to laterally outside the thresher device 2 to be supplied into a grain tank by a grain lifter device (not illustrated in the drawings). The second-grain guide 34 receives a second sorted product (that is, unsingled grains) falling through a back portion of the first chaff sieve 27 and a second sorted product (that is, unsingled grains) discharged backward from a back end portion of the second chaff sieve 28. The second-grain guide 34 guides the received second sorted product to the second-grain screw conveyor 31 to be collected thereby. The second-grain screw conveyor 31 conveys the collected second sorted product to laterally outside the thresher device 2 to be returned to a front portion of the thresher 2A by a returner device (not illustrated in the drawings).

The thresher cylinder 3 is bar-shaped and long to be capable of threshing a large amount of a threshing target. Even in response to the sorter 2B receiving a large amount of a processing target from the thresher 2A, the upper first chaff sieve 27 and the lower second chaff sieve 28 sort the processing target sufficiently to be mostly guided to and collected by the first-grain screw conveyor 30. The above configuration prevents the thresher 2A from being clogged by a large amount of a processing target returned to the thresher 2A.

### Configuration for Blowing Sorting Air

As illustrated in FIG. 1, the sorter 2B includes a winnowing fan 29 at a front portion thereof. The winnowing fan 29 includes a fan case 29a, rotary blades 29b, air intake ports 29c, and a discharge port 29d. The rotary blades 29b are disposed inside the fan case 29a, and have a rotation axis X extending widthwise relative to the sorter 2B. The air intake ports 29c are disposed at respective opposite lateral side portions of the fan case 29a and configured to draw in sorting air from outside the fan case 29a. The discharge port 29d is disposed at a back portion of the fan case 29a and configured to discharge sorting air backward along the first and second chaff sieves 27 and 28.

The winnowing fan 29 is at a front portion of the sorter 2B which front portion is outward of the sieve case 23. The sorter 2B includes a cylindrical air duct 35 between the winnowing fan 29 and the first and second chaff sieves 27 and 28. The air duct 35 has a front portion connected to the discharge port 29d of the winnowing fan 29 and a back portion with an air outlet 35a for blowing sorting air backward. The air duct 35 is connected to the discharge port 29d as a result of being formed integrally with the fan case 29a. The air outlet 35a is forward of and faces the first and second chaff sieves 27 and 28, and is inside the sieve case 23.

The air duct 35 includes a circumferential wall for guiding sorting air from the winnowing fan 29 toward the first chaff sieve 27. The air duct 35 contains a first guide 36 for guiding sorting air from the winnowing fan 29 toward the first chaff sieve 27 and a second guide 37 for guiding sorting air from the winnowing fan 29 toward the second chaff sieve 28.

FIG. 1 shows a vertical line L3 extending through the rotation axis X of the rotary blades 29b. As illustrated in FIG. 1, the winnowing fan 29 is so disposed at a front portion of the sorter 2B that the rotation axis X of the rotary blades 29b coincides with the raker section 13 in the front-back direction relative to the sorter 2B. This ensures a large distance between the winnowing fan 29 and the first and second chaff sieves 27 and 28, and allows use of a long air duct 35.

The winnowing fan 29 is configured such that the rotary blades 29b rotate to draw sorting air from laterally outside the winnowing fan 29 through the air intake ports 29c into the fan case 29a and discharge the sorting air backward from the winnowing fan 29 through the discharge port 29d. The air duct 35 receives the discharged sorting air thereinto. The circumferential wall of the air duct 35 and the first and second guides 36 and 37 guide the sorting air toward the first and second chaff sieves 27 and 28 to be blown through the air outlet 35a along the direction in which the first and second chaff sieves 27 and 28 extend.

### Alternative Embodiments

(1) The embodiment described above is configured such that the thresher cylinder shaft 5 is held horizontally. The thresher cylinder shaft 5 may alternatively be held as inclined with a back portion lifted.
(2) The embodiment described above is an example including an air duct 35, but may be altered to not include an air duct 35 and to blow sorting air directly from the discharge port 29d of the winnowing fan 29 toward the first and second chaff sieves 27 and 28.
(3) The embodiment described above is an example in which the air duct 35 is integral with the fan case 29a. The air duct 35 may alternatively be separate from the fan case 29a.
(4) The embodiment described above is an example in which the winnowing fan 29 is so positioned that the rotation axis X coincides with raker section 13. The present invention is, however, not limited to such an arrangement. The winnowing fan 29 may be at any position such that the rotation axis X is, for example, forward or backward of the raker section 13.

### INDUSTRIAL APPLICABILITY

The present invention is applicable to any combine including a thresher device including a thresher chamber configured to receive whole reaped crops, a receiver net, and a thresher cylinder with bar-shaped thresher teeth supports and bar-shaped thresher teeth.

### REFERENCE SIGNS LIST

2 Thresher device
2B Sorter
3 Thresher cylinder
4 Thresher chamber
5 Thresher cylinder shaft
8 Receiver net
13 Raker section
14 Thresher section
21a Thresher teeth support (front divisional thresher teeth support)
21b Thresher teeth support (rear divisional thresher teeth support)
22 Thresher teeth
23 Sieve case
27 First chaff sieve
28 Second chaff sieve
29 Winnowing fan
29b Rotary blade
30 First-grain screw conveyor
30c Center
31 Second-grain screw conveyor
31c Center
33 Guide (first-grain guide)
35 Air duct
35a Air outlet
X Rotation axis

1. A combine, comprising:
a reaper configured to reap a crop planted in an agricultural field; and
a thresher device comprising:
a thresher chamber configured to receive the whole reaped crop that the reaper has reaped;
a thresher cylinder disposed rotatably in the thresher chamber and configured to thresh the reaped crop that the thresher chamber has received;
a receiver net below the thresher cylinder; and
a sorter configured to sort a processing target falling through the receiver net,
the thresher cylinder comprising:
a thresher cylinder shaft disposed rotatably in the thresher chamber and extending in a front-back direction relative to the thresher chamber;
a plurality of bar-shaped thresher teeth supports held by and extending along the thresher cylinder shaft and apart from one another in a circumferential direction of the thresher cylinder; and
a plurality of bar-shaped thresher teeth provided for and held by each of the plurality of thresher teeth supports, protruding from the thresher teeth support outward in a radial direction of the thresher cylinder, and apart from one another along the thresher cylinder shaft, and
the sorter comprising:
a sieve case disposed below the receiver net and drivable to swing;
a first chaff sieve held inside the sieve case and configured to receive the processing target falling through the receiver net and sort the processing target while conveying the processing target backward relative to the sorter;
a second chaff sieve held by the sieve case in such a manner as to coincide with the first chaff sieve in a front-back direction relative to the sorter and be below the first chaff sieve and configured to receive the processing target falling through the first chaff sieve and sort the processing target while conveying the processing target backward relative to the sorter; and
a winnowing fan disposed at a front portion of the sorter and configured to blow sorting air backward relative to the sorter along the first and second chaff sieves.

2. The combine according to claim 1, wherein:
the thresher cylinder shaft is horizontal.

3. The combine according to claim 1, further comprising:
a first-grain screw conveyor disposed backward of the winnowing fan and configured to collect a first sorted product and convey the first sorted product widthwise relative to the sorter; and
a second-grain screw conveyor disposed backward of the first-grain screw conveyor and configured to collect a second sorted product and convey the second sorted product widthwise relative to the sorter,
wherein the first and second chaff sieves have respective front portions forward of a center of the first-grain screw conveyor, and
wherein the first and second chaff sieves have respective back portions backward of a center of the second-grain screw conveyor.

4. The combine according to claim 3, further comprising:
a guide extending from below the back portion of the second chaff sieve in a forward and downward direction past a space above the second-grain screw conveyor toward the first-grain screw conveyor and configured to guide the first sorted product to the first-grain screw conveyor.

5. The combine according to claim 1, wherein:
the winnowing fan is configured to draw in the sorting air from laterally outside the winnowing fan and discharge the sorting air backward relative to the winnowing fan, and
the combine further comprises a cylindrical air duct disposed between the winnowing fan and the first and second chaff sieves and configured to guide the sorting air from the winnowing fan toward the first and second chaff sieves.

6. The combine according to claim 5, wherein:
the air duct has an air outlet forward of and facing the first and second chaff sieves.

7. The combine according to claim 5, wherein:
the air duct is configured to blow the sorting air along a direction in which the first and second chaff sieves extend.

8. The combine according to claim 5, wherein:
the thresher cylinder further comprises:
a raker section disposed at a front portion of the thresher cylinder and configured to rake backward relative to the thresher chamber the reaped crop that the thresher chamber has received; and
a thresher section connected to a back portion of the raker section and comprising the thresher teeth supports and the thresher teeth, and
the winnowing fan comprises a rotary blade with a rotation axis extending widthwise relative to the sorter and coinciding with the raker section in the front-back direction relative to the sorter.
